(19) United States
(12) Patent Application Publication
(10) Pub. No.: US 2021/0329925 A1
(43) Pub. Date: Oct. 28, 2021

(54) METHOD FOR ENHANCING THE GROWTH AND SURVIVAL RATE OF MICROORGANISMS

(71) Applicant: Danstar Ferment AG, Zug (CH)

(72) Inventors: Mike Whiting, Saskatoon (CA); Tyler Boa, Allan (CA)

(21) Appl. No.: 17/312,848

(22) PCT Filed: Dec. 11, 2019
(86) PCT No.: PCT/IB2019/060666

§ 371 Date: Jun. 10, 2021

Related U.S. Application Data
(60) Provisional application No. 62/778,167, filed on Dec. 11, 2018.

(51) Int. Cl. A01N 63/20; A01N 63/36; A01N 63/38

(52) U.S. Cl. CPC A01N 63/20; A01N 63/38; A01N 63/36

(57) ABSTRACT

The present disclosure concerns a method for enhancing or promoting or increasing the fermentative potential of microbial populations and/or the growth rate of microorganisms. The present disclosure also proposes a method for improving survival, viability and/or stability of microorganisms in microbial products, suspensions or of microbial inoculants, during storage.

### CROSS-REFERENCE TO RELATED APPLICATIONS

This application claims priority from U.S. provisional application Ser. No. 62/778,167 filed on Dec. 11, 2018 and herewith incorporated in its entirety.

### TECHNOLOGICAL FIELD

The present disclosure relates to a method for enhancing, promoting or increasing the fermentative potential of a microbial population and/or the growth rate of microorganisms. The present disclosure also proposes a method for improving survival, viability and/or stability of microorganisms in microbial suspensions and when applied to solid supports as granules or seeds.

### BACKGROUND

It is well known that microorganisms have uses and benefits across all aspect of life and are implemented for different industrial applications. Fields of application are covering industrial processes related to, for example, food industry, medicine, agriculture, chemical industry, energy industry, biomass conversion field and other areas. Most of these processes use the ability of microorganisms to produce cell biomass, proteins and/or primary and/or secondary metabolites.

For example, there is increasing interest in the use of beneficial microorganisms as alternatives to synthetic fertilizers and chemical pesticides in agriculture. More particularly, the use of microorganisms for plant growth promotion and disease control is well recognized. Isolation of microorganisms, screening for desirable characters, selecting of efficient strains and producing inoculums are important steps for using this microbe-based technology. Beneficial microorganisms can be introduced by the use of liquid suspensions which can be applied directly onto seeds of plants or onto granular support, or can be applied on seedlings, foliage or soil (prior or after planting seeds).

To produce a large, stable and efficacious biomass for each microbial agent for use in microbial suspension as, for example in inoculant formulations, intensive study is needed to identify the optimal production method (solid state or submerged fermentation) and medium components, production parameters (e.g. temperature, oxygen transfer rate, time and method of harvest) and post-harvest treatment of cell biomass (Hynes and Boyetchko, 2006). For example, for most bacteria used in plant growth formulations are usually prepared by growing the organisms as aseptic liquid cultures, harvested, and the bacterial suspension is diluted to give a desired concentration of viable bacteria/ml (usually ≥10⁸ cfu/ml).

It is well known that nutrient products used in fermentations do not necessarily significantly increase cell number or increase cell viability and vitality. Furthermore, at the end of fermentation, it is often difficult to maintain a sufficient population and the viability of microorganisms during all the downstream manufacturing processes, packaging and storage. Maintaining viability of the microbes after their application to seeds, soils, plants or in food products is also as important as maintaining viability during the storage period and/or product shelf life.

Accordingly, there is a need to provide novel approaches to increasing microbial cell biomass and viability yield during fermentation. There is also a need for a method for enhancing survival rate and stability of microorganisms in suspensions during storage and for improving survival and stability of a microorganism once placed on a solid support such as granules, seeds, fertilizers or plant tissues.

### BRIEF SUMMARY

The present disclosure relates to a method of enhancing or promoting growth of microorganisms during fermentation which is based on the discovery that it is possible to obtain a significant enhancement of biomass yield and microbial viability by using a protective agent (e.g., biochar particles, activated carbon and/or charcoal) during the step of fermenting the microorganisms. The present disclosure further relates to a method of preparing a liquid inoculant or microbial suspension comprising the addition of the protective agent to the liquid inoculant or microbial suspension after the microorganisms have been grown (in the presence or in the absence of the protective agent) and entered stationary phase. This method can provide for increased viability and stability and enhanced shelf life of the microorganisms when the inoculant or microbial suspension is stored or in pack, i.e. contained in a package and/or is applied to solid supports as granules or seeds.

According to a first aspect, the present disclosure concerns a method for increasing the yield, growth, growth rate, survival rate and/or viability of a population of microorganisms. The method comprises contacting a protective agent comprising biochar particles, activated carbon and/or charcoal with the population of microorganisms to obtain a mixture. In an embodiment, the protective agent comprises or consists essentially of biochar particles. In another embodiment, the protective agent comprises or consists essentially of activated carbon. In still another embodiment, the protective agent is added at a concentration of 0.01% to 50%, 0.05% to 20%, 0.1% to 15%, 0.1% to 10% or 0.1% to 5% weight/volume of the mixture. In a further embodiments, the mixture further comprises a medium. In an embodiment, the medium is a liquid medium. In a specific embodiment in which the medium is a liquid medium, the mixture can be a liquid inoculant. In another embodiment, the medium is a solid medium, such as, for example, a solid substrate. In a specific embodiment in which the medium is a solid substrate, the mixture can be a microbial inoculant immobilized in the solid substrate. In an embodiment, the method further comprises storing the mixture. In some specific embodiments, the method further comprises packaging the mixture (in a pack for example). In still another embodiment, the population of microorganisms was grown in the absence of the protective agent. In a further embodiment, the population of microorganisms was grown in the presence of the protective agent. In a specific embodiment, the presence of the protective agent reduces the loss during storage of the population of microorganisms by 1%, 5%, 10%, 15%, 20%, 25%, 30%, 35%, 40%, 45%, 50%, 55%, 60%, 65%, 70%, 75%, 80%, 90%, 95% or 100% or by no more than 0.1 log CFU, 0.2 log CFU, 0.3 log CFU 0.4 log CFU, 0.5 log CFU, 0.6 log CFU, 0.7 log CFU, 0.8 log CFU, 0.9 log CFU, 1 log CFU, 1.1 log CFU, 1.2 log CFU, 1.3 log CFU, 1.4 log CFU, 1.5 log CFU, 1.6 log CFU, 1.7 log CFU, 1.8 log CFU, 1.9 log CFU or 2 log CFU when compared to a corresponding population of microorganisms in a control mixture which does not comprise the protective agent. In an embodiment, the medium is capable of supporting growth of the population of microorganisms. In some embodiments, the method further comprises fermenting the population of microorganisms. In an embodiment, the protective agent is added to the medium prior to or at the beginning of the fermenting step. Alternatively or in combination, the protective agent can be added to the medium between the early-log growth phase and the late-log growth phase of the fermenting step. Alternatively or in combination, the protective agent can be added to the medium before the stationary phase of the fermenting step. Alternatively or in combination, the protective agent can be added to the medium at the stationary phase of the fermenting step. In an embodiment, the method further comprises, after the fermenting step, adding the protective agent to the population of microorganisms. In some embodiments, the method further comprises storing the population of microorganisms comprising the protective agent. In some embodiments, the yield of the population of microorganism during fermentation is increased by 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290 or 300% when compared to a corresponding population of microorganisms fermented in the absence of the protective agent. In some embodiments, the protective agent comprises particles having a size less than 1000, 950, 900, 850, 800, 750, 700, 650, 600, 550, 500, 450, 400, 350, 300, 250, 200, 150, 100 or 50 microns. In yet additional embodiments, the size of the particles is less than 350, 300, 250, 200 or 150 microns. In embodiments, the population of microorganisms comprise bacterial or fungal cells. In some embodiments, the bacterial or fungal cells are from the genera Achromobacter, Actimomycetes, Agrobacterium, Arthrobacter, Azospirillum, Azotobacter, Bacillus, Bifidobacterium, Bradyrhizobium, Chromobacterium, Cyanobacteria, Delftia, Enterobacter, Herbaspirillum, Klebsiella, Lactobacillus, Lactococcus, Lysobacter, Methylobacterium, Mitsuaria, Paenibacillus, Pasteuria, Pseudomonas, Rhizobium, Serratia, Sinorhizobium, Streptococcus, Streptomyces, Beauveria, Metarhizium, Isaria, Penicillium, Trichoderma, Chaetomium, Piriformospora, Phlebiopsis or Clonostachys. In other embodiments, the bacterial or fungal cells are from the genera Azospirillum, Bradyrhizobium, Delftia, Herbaspirillum, Mesorhizobium, Rhizobium, Sinorhizobium, Piriformospora, Phlebiopsis or Streptomyces. In some additional embodiments, the bacterial or fungal cells comprise or Sinorhizobium meliloti. In further embodiments, the bacterial cells comprise Bradyrhizobium elkanii, Delftia acidovorans, Bradyrhizobium japonicum, Herbaspirillum huttiense, Rhizobium leguminosarum or Azospirillum brazilense.

According to a second aspect, the present disclosure provides a microbial composition comprising (i) a population of microorganisms and (ii) a protective agent comprising biochar particles, activated carbon, and/or charcoal. In some embodiments, the protective agent comprises or consists essentially of biochar particles. In additional embodiments, the protective agent comprises or consists essentially of activated carbon. In some embodiments, the microbial composition further comprises (iii) a medium. In an embodiment, the medium is a liquid medium. In embodiments in which the medium is a liquid medium, the microbial composition can be a liquid inoculant. In another embodiment, the medium is a solid medium, a solid substrate for example. In embodiments in which the medium is a solid substrate, the microbial composition can be a microbial inoculant immobilized in the solid substrate. In a further embodiment, the medium is capable of supporting the growth of the population of microorganisms. In embodiments, the protective agent is present at a concentration of 0.01% to 50%, 0.05% to 20%, 0.1% to 15%, 0.1% to 10% or 0.1% to 5% weight/volume of the microbial composition. In a further embodiment, the protective agent comprises particles having a size less than 1000, 950, 900, 850, 800, 750, 700, 650, 600, 550, 500, 450, 400, 350, 300, 250, 200, 150, 100 or 50 microns. In yet another embodiment, the size of the particles is less than 350, 300, 250, 200 or 150 microns. In a further embodiment, the population of microorganisms comprise bacterial or fungal cells. In an embodiment, the bacterial or fungal cells are from the genera Achromobacter, Actimomycetes, Agrobacterium, Arthrobacter, Azospirillum, Azotobacter, Bacillus, Bifidobacterium, Bradyrhizobium, Chromobacterium, Cyanobacteria, Delftia, Enterobacter, Herbaspirillum, Klebsiella, Lactobacillus, Lactococcus, Lysobacter, Methylobacterium, Mitsuaria, Paenibacillus, Pasteuria, Pseudomonas, Rhizobium, Serratia, Sinorhizobium, Streptococcus, Streptomyces, Beauveria, Metarhizium, Isaria, Penicillium, Trichoderma, Chaetomium, Piriformospora, Phlebiopsis or Clonostachys. In still another embodiment, the bacterial or fungal cells are from the genera Azospirillum, Bradyrhizobium, Delftia, Herbaspirillum, Mesorhizobium, Rhizobium, Sinorhizobium, Piriformospora, Phlebiopsis or Streptomyces. In a further embodiment, the bacterial or fungal cells comprise Bradyrhizobium elkanii, Bradyrhizobium diazoefficiens, Delftia acidovorans, Bradyrhizobium japonicum, Rhizobium leguminosarum, Rhizobium tropici, Mesorhizobium loti, Azospirillum brazilense, Herbaspirillum huttiense, Streptomyces griseoviridis, Piriformospora indica, or Sinorhizobium meliloti. In yet another embodiment, the bacterial cells comprise Bradyrhizobium elkanii, Delftia acidovorans, Bradyrhizobium japonicum, Herbaspirillum huttiense, Rhizobium leguminosarum or Azospirillum brazilense.

According to a third aspect, the present disclosure provides a method for increasing the yield, growth, growth rate and/or viability of a population of microorganisms in a microbial suspension, the method comprises (a) contacting the population of microorganisms with a liquid medium capable of supporting growth of the population of microorganisms; and (b) providing biochar particles to the liquid medium and culturing the population of microorganisms to produce a microbial suspension wherein the biochar particles increase the yield, growth, growth rate and/or viability of the population of microorganisms in the microbial suspension as compared to the yield, growth, growth rate and/or viability of the population of microorganisms cultured in the absence of biochar. In an embodiment, the biochar particles are provided at a concentration of 0.01% to 50%, 0.05% to 20%, 0.1% to 15%, about 0.1% to about 10% or about 0.1% to 5% by weight/volume of the liquid medium. In an embodiment, the biochar particles are added to the liquid medium at the beginning of the fermentation. In another specific embodiment, the biochar particles are added to the liquid medium between the early-log growth phase and the late-log growth phase. In another specific embodiment, the biochar particles are added to the liquid medium before the stationary phase. In another specific embodiment, the biochar particles are added to the liquid medium at the stationary phase. In still another embodiment, the method further comprises, after step (b), (c) adding to the microbial suspension biochar particles to enhance the survival rate and/or reduce the loss of the population of microorganisms during storage. In an embodiment, the biochar particles have particle size less than 1000, 950, 900, 850, 800, 750, 700, 650, 600, 550, 500, 450, 400, 350, 300, 250, 200, 150, 100 or 50 microns. For example, the biochar particles have particle size less than 350, 300, 250, 200 or 150 microns. In an embodiment, the microorganisms are from the genera Achromobacter, Actimomycetes, Agrobacterium, Arthrobacter, Azospirillum, Azotobacter, Bacillus, Bifidobacterium, Bradyrhizobium, Chromobacterium, Cyanobacteria, Delftia, Enterobacter, Herbaspirillum, Klebsiella, Lactobacillus, Lactococcus, Lysobacter, Methylobacterium, Mitsuaria, Paenibacillus, Pasteuria, Pseudomonas, Rhizobium, Serratia, Sinorhizobium, Streptococcus and Streptomyces, Beauveria, Metarhizium, Penicillium, Trichoderma, Chaetomium, Piriformospora, Phlebiopsis or Clonostachys. In a specific embodiment, the microorganisms are from the genera Azospirillum, Bradyrhizobium, Delftia, Herbaspirillum, Mesorhizobium, Rhizobium Sinorhizobium or Streptomyces. For example, the microorganisms comprise Bradyrhizobium elkanii, Bradyrhizobium diazoefficiens, Delftia acidovorans, Bradyrhizobium japonicum, Rhizobium leguminosarum, Rhizobium tropici, Mesorhizobium loti, Azospirillum brazilense, Herbaspirillum huttiense, Streptomyces griseoviridis, Piriformospora indica, Sinorhizobium meliloti. In an embodiment, the biochar particles increase the yield, growth, growth rate and/or viability of a population of microorganisms by at least 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290 or 300% when compared to the yield, growth, growth rate and/or the viability of the of a population of microorganisms cultured in the absence of biochar. In a another specific embodiment, the yield of the population of microorganism is increase by at least 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290 or 300% when compared to the yield of a population of microorganisms cultured in the absence of biochar. In an embodiment, the present disclosure provides a plant seed, a granule or a fertilizer comprising the microbial composition as described herein.

According to a fourth aspect, the present disclosure provides a method for increasing the survival rate of a population of microorganisms in a liquid inoculant or microbial suspension, the method comprises (a) providing the liquid inoculant or microbial suspension comprising the population of microorganisms grown to a substantially stationary phase; and (b) adding to the liquid inoculant or microbial suspension biochar particles to enhance the survival rate and/or reduce the loss of the population of microorganisms during storage compared to the survival rate of population of microorganisms in a liquid inoculant or microbial suspension which does not comprise biochar particles. In an embodiment, the biochar particles are added at a concentration of 0.01% to 50%, 0.05% to 20%, 0.1% to 15%, about 0.1% to about 10% or about 0.1% to 5% by weight/volume of the liquid inoculant or microbial suspension. In an embodiment, the population of microorganisms of the liquid inoculant or microbial suspension was grown in absence of biochar particles. In another embodiment, the population of microorganisms of the liquid inoculant or microbial suspension was grown in presence of biochar particles. In still another embodiment, the biochar particles have particle size less than 1000, 950, 900, 850, 800, 750, 700, 650, 600, 550, 500, 450, 400, 350, 300, 250, 200, 150, 100 or 50 microns. For example, the biochar particles have particle size less than 350, 300, 250, 200 or 150 microns. In an embodiment, the microorganisms are from the genera Achromobacter, Actimomycetes, Agrobacterium, Arthrobacter, Azospirillum, Azotobacter, Bacillus, Bifidobacterium, Bradyrhizobium, Chromobacterium, Cyanobacteria, Delftia, Enterobacter, Herbaspirillum, Klebsiella, Lactobacillus, Lactococcus, Lysobacter, Methylobacterium, Mitsuaria, Paenibacillus, Pasteuria, Pseudomonas, Rhizobium, Serratia, Sinorhizobium, Streptococcus and Streptomyces, Beauveria, Metarhizium, Penicillium, Trichoderma, Chaetomium, or Clonostachys. In another embodiment, the microorganisms are from the genera Azospirillum, Bradyrhizobium, Delftia, Herbaspirillum, Mesorhizobium, Rhizobium Sinorhizobium or Streptomyces. For example, the microorganisms comprise Bradyrhizobium elkanii, Bradyrhizobium diazoefficiens, Delftia acidovorans, Bradyrhizobium japonicum, Rhizobium leguminosarum, Rhizobium tropici, Mesorhizobium loti, Azospirillum brazilense, Herbaspirillum huttiense, Streptomyces griseoviridis, Sinorhizobium meliloti. In an embodiment, the addition of biochar particles reduces the loss of the population of microorganisms by at least 1%, 5%, 10%, 15%, 20%, 25%, 30%, 35%, 40%, 45%, 50%, 55%, 60%, 65%, 70%, 75%, 80%, 90%, 95% or 100% when compared to the reduction rate observed in population of microorganisms in a liquid inoculant or microbial suspension which does not comprise biochar particles. In still another embodiment, the population of microorganisms experiences a reduction in population of less than 0.1 log cfu, 0.2 log cfu, 0.3 log cfu, 0.4 log cfu, 0.5 log cfu, 0.6 log cfu, 0.7 log cfu, 0.8 log cfu, 0.9 log cfu, 1 log cfu, 1.1 log cfu, 1.2 log cfu, 1.3 log cfu, 1.4 log cfu, 1.5 log cfu, 1.6 log cfu, 1.7 log cfu, 1.8 log cfu, 1.9 log cfu or 2 log cfu when compared to the reduction rate observed in population of microorganisms in a liquid inoculant or microbial suspension which does not comprise biochar particles.

According to a fifth aspect, the present disclosure is directed to the use of biochar for obtaining increased yields of a microorganism culture fermented in a liquid medium compared to yields of a microorganism culture fermented in absence of biochar wherein the biochar is added to the liquid medium capable of supporting growth of the microorganisms. In an embodiment, the biochar is provided at a concentration of 0.01% to 50%, 0.05% to 20%, 0.1% to 15%, about 0.1% to about 10% or about 0.1% to 5% by weight/volume of the liquid medium. In an embodiment, the biochar is added to the liquid medium at the beginning of the fermentation. In another embodiment, the biochar is added to the liquid medium between the early-log growth phase and the late-log growth phase. In still another embodiment, the biochar is added to the liquid medium before the stationary phase. In yet another embodiment, the biochar is added to the liquid medium at the stationary phase. In an embodiment, the biochar has particle size less than 1000, 950, 900, 850, 800, 750, 700, 650, 600, 550, 500, 450, 400, 350, 300, 250, 200, 150, 100 or 50 microns. For example, the biochar has particle size less than 350, 300, 250, 200 or 150 microns. In an embodiment, the microorganisms are from the genera Achromobacter, Actimomycetes, Agrobacterium, Arthrobacter, Azospirillum, Azotobacter, Bacillus, Bifidobacterium, Bradyrhizobium, Chromobacterium, Cyanobacteria, Delftia, Enterobacter, Herbaspirillum, Klebsiella, Lactobacillus, Lactococcus, Lysobacter, Methylobacterium, Mitsuaria, Paenibacillus, Pasteuria, Pseudomonas, Rhizobium, Serratia, Sinorhizobium, Streptococcus and Streptomyces, Beauveria, Metarhizium, Penicillium, Trichoderma, Chaetomium, or Clonostachys. In another embodiment, the microorganisms are from the genera Azospirillum, Bradyrhizobium, Delftia, Herbaspirillum, Mesorhizobium, Rhizobium Sinorhizobium or Streptomyces. For example, the microorganisms comprise Bradyrhizobium elkanii, Bradyrhizobium diazoefficiens, Delftia acidovorans, Bradyrhizobium japonicum, Rhizobium leguminosarum, Rhizobium tropici, Mesorhizobium loti, Azospirillum brazilense, Herbaspirillum huttiense, Streptomyces griseoviridis, Sinorhizobium meliloti. In an embodiment, the yield is increase by at least 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290 or 300% when compared to the population of microorganisms cultured in the absence of biochar for a same period of time.

According to a sixth aspect, the present disclosure is directed to the use of biochar for increasing the survival rate of a population of microorganisms in a liquid inoculant or microbial suspension compared to the survival rate of population of microorganisms in a liquid inoculant or microbial suspension which does not comprise biochar particles, wherein said biochar is added to the liquid inoculant or microbial suspension comprising the population of microorganisms grown to a substantially stationary phase. In an embodiment, the biochar is added at a concentration of 0.01% to 50%, 0.05% to 20%, 0.1% to 15%, about 0.1% to about 10% or about 0.1% to 5% by weight/volume of the liquid inoculant or microbial suspension. In an embodiment, the population of microorganisms of the liquid inoculant or microbial suspension was grown in absence of biochar. In another embodiment, the population of microorganisms of the liquid inoculant or microbial suspension was grown in presence of biochar. In still another embodiment, the biochar has particle size less than 1000, 950, 900, 850, 800, 750, 700, 650, 600, 550, 500, 450, 400, 350, 300, 250, 200, 150, 100 or 50 microns. For example, the biochar has particle size less than 350, 300, 250, 200 or 150 microns. In an embodiment, the microorganisms are from the genera Achromobacter, Actimomycetes, Agrobacterium, Arthrobacter, Azospirillum, Azotobacter, Bacillus, Bifidobacterium, Bradyrhizobium, Chromobacterium, Cyanobacteria, Delftia, Enterobacter, Herbaspirillum, Klebsiella, Lactobacillus, Lactococcus, Lysobacter, Methylobacterium, Mitsuaria, Paenibacillus, Pasteuria, Pseudomonas, Rhizobium, Serratia, Sinorhizobium, Streptococcus and Streptomyces, Beauveria, Metarhizium, Penicillium, Trichoderma, Chaetomium, or Clonostachys. In another embodiment, the microorganisms are from the genera Azospirillum, Bradyrhizobium, Delftia, Herbaspirillum, Mesorhizobium, Rhizobium Sinorhizobium or Streptomyces. For example, the microorganisms comprise Bradyrhizobium elkanii, Bradyrhizobium diazoefficiens, Delftia acidovorans, Bradyrhizobium japonicum, Rhizobium leguminosarum, Rhizobium tropici, Mesorhizobium loti, Azospirillum brazilense, Herbaspirillum huttiense, Streptomyces griseoviridis, Sinorhizobium meliloti. In an embodiment, the population of microorganisms experiences a reduction in population of less than 0.1 log CFU, 0.2 log CFU, 0.3 log CFU, 0.4 log CFU, 0.5 log CFU, 0.6 log CFU, 0.7 log CFU, 0.8 log CFU, 0.9 log CFU, 1 log CFU, 1.1 log CFU, 1.2 log CFU, 1.3 log CFU, 1.4 log CFU, 1.5 log CFU, 1.6 log CFU, 1.7 log CFU, 1.8 log CFU, 1.9 log CFU or 2 log CFU compared to the survival rate of population of microorganisms in a liquid inoculant or microbial suspension which does not comprise biochar particles.

### BRIEF DESCRIPTION OF THE DRAWINGS

Having thus generally described the nature of the invention, reference will now be made to the accompanying drawings, showing by way of illustration, a preferred embodiment thereof, and in which:

FIG. 1 illustrates the amount of B. elkanii strains SEMIA 587 and SEMIA 5019 cells after culturing in M1 and M2 liquid medium and M1 and M2 liquid medium supplemented with biochar.

FIG. 2 illustrates the effect of different protective agents on the viability of R. leguminosarum strains INRA P221 and INRA P1NP1J in different period of times: (♦) R. leguminosarum strains alone (negative control); (▪) protective agent comprising 0.6% polyvinylpyrrolidone (PVP) and 0.1% phosphate buffer at a ratio of bacteria:polymer protective agent of 1:1; and (▴) protective agent comprising 1% biochar (particle size 70 mesh) and 0.1% phosphate buffer at a ratio of bacteria:biochar of 1:1.

FIG. 3 illustrates the effect of different protective agents and storage intervals on the pH of the storage media in different period of times on the viability of R. leguminosarum strain INRA P221 and strain INRA P1NP1J: (♦) R. leguminosarum strains alone (negative control); (▪) protective agent comprising 0.6% polyvinylpyrrolidone (PVP) and 0.1% phosphate buffer at a ratio of bacteria:polymer protective agent of 1:1; and (▴) protective agent comprising 1% biochar (particle size 70 mesh) and 0.1% phosphate buffer at a ratio of bacteria:biochar of 1:1.

FIG. 4 illustrates the effect of different protective agents, in conjunction with a standard culture medium (F1), on the viability of D. acidovorans strain Ray 209 in different period of times: (♦) protective agent comprising 0.15% sodium carboxymethylcellulose (CMC) and 9% trehalose at a ratio of bacteria:protective agent of 1:3; (▪) protective agent comprising 0.45% polyvinylpyrrolidone (PVP) and 0.1% phosphate buffer at a ratio of bacteria:polymer protective agent of 1:3 and (▴) a protective agent comprising 0.5% biochar (particle size 70 mesh) and 0.1% phosphate buffer at a ratio of bacteria:protective agent of 1:3.

FIG. 5 illustrates the effect of different protective agents, in conjunction with a culture medium supplemented with biochar (F2), on the viability of D. acidovorans strain Ray 209 in different period of times: (♦) protective agent comprising 0.15% sodium carboxymethylcellulose (CMC) and 9% trehalose at a ratio of bacteria:protective agent of 1:3; (▪) protective agent comprising 0.45% polyvinylpyrrolidone (PVP) and 0.1% phosphate buffer at a ratio of bacteria:polymer protective agent of 1:3 and (▴) protective agent comprising 0.5% biochar (particle size 70 mesh) and 0.1% phosphate buffer at a ratio of bacteria:protective agent of 1:3.

FIG. 6 illustrates the effect of different protective agents, in conjunction with culture medium supplemented with phosphate buffer (F3), on the viability of D. acidovorans strain Ray 209 in different period of times: (♦) protective agent comprising 0.15% sodium carboxymethylcellulose (CMC) and 9% trehalose at a ratio of bacteria:protective agent of 1:3; (▪) protective agent comprising 0.45% polyvinylpyrrolidone (PVP) and 0.1% phosphate buffer at a ratio of bacteria:polymer protective agent of 1:3 and (▴) protective agent comprising 0.5% biochar (particle size 70 mesh) and 0.1% phosphate buffer at a ratio of bacteria:protective agent of 1:3.

FIG. 7 illustrates the effect of different protective agents, in conjunction with culture medium supplemented with phosphate buffer and biochar (F4), on the viability of D. acidovorans strain Ray 209 in different period of times: (♦) protective agent comprising 0.15% sodium carboxymethylcellulose (CMC) and 9% trehalose at a ratio of bacteria:protective agent of 1:3; (▪) protective agent comprising 0.45% polyvinylpyrrolidone (PVP) and 0.1% phosphate buffer at a ratio of bacteria:polymer protective agent of 1:3 and (▴) protective agent comprising 0.5% biochar (particle size 70 mesh) and 0.1% phosphate buffer at a ratio of bacteria:protective agent of 1:3.

FIG. 8 illustrates the viability count (in CFU/ml) of Azospirillum brasilense (AZOS; Lallemand Plant Care) after culturing in a standard liquid medium, without (pure culture, dotted line) or supplemented with biochar (solid line).

FIG. 9 illustrates the effect at different storage times of different diluents on the viability (CFU/ml) of a Herbaspirillum huttiense strain suspension grown on a standard culture medium (ENDORICE; Lallemand Plant Care): (solid line) H. huttiense suspension alone (control); (dashed line) addition of 1 volume of a 0.1% phosphate buffer at pH 7; and (dotted line) addition of 1 volume of a suspension of 1% biochar (particle size 70 mesh) in a 0.1% phosphate buffer at pH 7.

FIG. 10 illustrates the effect at different storage times of different diluents on the viability (CFU/ml) of a suspension of D. acidovorans strain Ray 209 grown in a standard medium: suspension alone (control, dotted line); addition of 3 volumes of a 0.1% phosphate buffer at pH 7 (dashed line); and addition of 3 volumes of a suspension of 0.75% biochar (particle size 70 mesh) in a 0.1% phosphate buffer at pH 7 (solid line).

FIG. 11 illustrates the effect at different storage times of different concentrations of biochar on the viability (expressed as the percentage of the initial viability) of R. leguminosarum strains INRA P221 and INRA P1NP1J grown in a standard medium: suspension alone (control, dotted line); biochar at 1 g/L (solid line); biochar at 5 g/L (dashed line, small); and biochar at 10 g/L (dashed line, small).

FIG. 12 illustrates the viability count (in CFU/ml) of R. leguminosarum INRA P221 and INRA P1NP1J after culturing in a standard liquid medium supplemented with biochar at 1 g/L (solid line) or 5 g/L (dashed line) or a control liquid medium (pure culture, dotted line).

FIG. 13 illustrates the viability count (in CFU/ml) of B. elkanii strains SEMIA 587 and SEMIA 5019 after culturing in a standard liquid medium supplemented with activated carbon at 5 g/L (solid line) or a control liquid medium (pure culture, dotted line).

FIG. 14 illustrates the effect at different storage time of B. elkanii strains SEMIA 587 and SEMIA 5019 after culturing in standard medium supplement with concentrations of activated carbon on the viability (CFU/ml): suspension alone (pure culture, dotted line); activated carbon 0.5 g/L (dashed line) or activated carbon 5 g/L (solid line).

### DETAILED DESCRIPTION

The present disclosure concerns the addition of a protective agent (biochar particles or biochar, activated carbon and/or charcoal) during the fermentation or to a microbial culture (or an inoculant composition) to (1) stimulate or promote the growth of the microorganisms during fermentation, (2) enhance or increase the shelf life or the survival rate and stability upon storage of the microorganisms in subsequent steps such as packaging and storing, and/or (3) improve the stability and survival of the microorganisms in subsequent steps such as, for example, on-seed, on fertilizers and/or in-furrow application.

By “stimulating, increasing, enhancing or promoting yield or growth” or “stimulating, increasing, enhancing or promoting the growth rate” as used herein, it is meant that the growth of the microorganisms or the growth of the population of microorganisms grown in presence of the protective agent is enhanced over growth which would be obtained in the absence of the protective agent. In the context of the present disclosure, the growth rate of microorganisms or the population of microorganisms is enhanced over growth which would normally be expected from a medium typically used to grow that type of microorganism in the absence of the protective agent. In a particular example, the protective agent increases the activity of a microorganism, such as increasing or enhancing the growth, population, biomass yield, reproduction, proliferation, survival rate, metabolism, vitality, robustness, action, and/or function of a microorganism by at least about 10%, 20%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, or more than 300% relative to the activity, e.g., growth, population, biomass yield, reproduction, proliferation, survival rate, metabolism, vitality, robustness, action, and/or function of a corresponding microorganism culture obtained when culturing or fermenting the cells in the absence of the protective agent. In another example, the protective agent increases or enhances fermentation efficiency or culturing efficiency of a microorganism such as by at least about 10%, 20%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, or more than 300% relative to fermentation efficiency or culturing efficiency of the corresponding microorganism obtained when culturing or fermenting in the absence of the protective agent. Such increase can be measured using any methods known in the art. In the present context, the term “yield” refers to the amount of viable microorganism cells or microorganism biomass produced in a fermentation of a given volume.

As used herein, the term “enhancing or improving viability” means enhancing or increasing the likelihood of survival of a microorganism which has been contacted with or exposed to the protective agent during fermentation and/or storage compared to the likelihood of survival of a microorganism which has not been contacted or exposed to the protective agent (e.g., in the absence of the protective agent).

The term “viability” of cells denotes their status to be alive. That status can be expressed by surviving, growing and multiplying of cells and is for many issues verifiable by a positive cultivability. Viability can be measured by many different ways as it is known in the art.

The term “stability” as used herein relates to the ability of maintaining viability over a certain time period or after processing, processing including processing the microorganisms to microbial product compositions, as extruding, lyophilizing, freezing, drying, storage and/or when applied to seeds, on granules or in-furrow.

As used herein, the term “increasing or enhancing the survival rate” means retaining a concentration of viable microorganisms as close as possible to the concentration just after the manufacture of the liquid suspensions or microbial suspension or the addition of the protective agent to a medium (solid or liquid) during a determined storage period at a determined temperature over survival rate which would be obtained in the absence of the protective agent.

The term “increasing stability” as used herein means, amongst other, that the population of microorganisms retain sufficient viability and survival rate during the storage or once applied on solid supports, granules, seeds, seedlings, foliage or soil. In an embodiment, the addition of the protective agent reduces the loss of microorganisms by at least 1%, 5%, 10%, 15%, 20%, 25%, 30%, 35%, 40%, 45%, 50%, 55%, 60%, 65%, 70%, 75%, 80%, 90%, 95% or 100% compared to the reduction rate observed in a corresponding population of microorganisms which were not contacted with the protective agent (e.g., in a control mixture in the absence of the protective agent). Alternatively, in presence of the protective agent, the microorganism experiences a reduction in population of less than 0.1 log CFU, 0.2 log CFU, 0.3 log CFU, 0.4 log CFU, 0.5 log CFU, 0.6 log CFU, 0.7 log CFU, 0.8 log CFU, 0.9 log CFU, 1 log CFU, 1.1 log CFU, 1.2 log CFU, 1.3 log CFU, 1.4 log CFU, 1.5 log CFU, 1.6 log CFU, 1.7 log CFU, 1.8 log CFU, 1.9 log CFU or 2 log CFU compared to the reduction rate observed in a corresponding population of microorganisms which were not contacted with the protective agent (e.g., in a control mixture in the absence of the protective agent).

In the context of the present disclosure, the population of microorganisms can comprise bacteria, yeast or fungi. In a specific embodiment, the population of microorganisms can comprise or consist essentially of bacteria. In a specific embodiment, the population of microorganisms can comprise or consist essentially of yeast or fungi. In some embodiments, the microorganisms can be from the genus Achromobacter, Actimomycetes, Agrobacterium, Arthrobacter, Azospirillum, Azotobacter, Bacillus, Bifidobacterium, Bradyrhizobium, Chromobacterium, Cyanobacteria, Delftia, Enterobacter, Herbaspirillum, Klebsiella, Lactobacillus, Lactococcus, Lysobacter, Methylobacterium, Mesorhizobium, Mitsuaria, Paenibacillus, Pasteuria, Pseudomonas, Rhizobium, Serratia, Sinorhizobium, Streptococcus or Streptomyces. In other embodiments, the microorganisms can be of the genus Beauveria, Metarhizium, Isaria, Penicillium, Trichoderma, Chaetomium, Clonostachys, Piriformospora, Phlebiopsis or mycorrhizal fungi. In an embodiment, the microorganisms can be from the genus Azospirillum, Bradyrhizobium, Delftia, Herbaspirillum, Mesorhizobium, Sinorhizobium or Rhizobium. In some embodiments, the microorganism is Rhizobium leguminosarum, Rhizobium tropici, Mesorhizobium loti, Bradyrhizobium japonicum, Bradyrhizobium elkanii, Bradyrhizobium diazoefficiens, Delftia acidovorans, Azospirillum brazilense, Herbaspirillum huttiense, Streptomyces griseoviridis, Piriformospora indica or Sinorhizobium meliloti. Plural microorganisms of different genus, species or strains can be used in combination.

The protective agent of the present disclosure is a carbon-rich mixture (e.g., comprising more than 50% of carbon) which has been obtained from thermally treating a biomass or another carbonaceous mixture. For example, the protective agent can refer to a solid material obtained from the pyrolysis, torrefaction, gasification or any other thermal and/or chemical conversion of a biomass or another carbonaceous mixture. The protective agent can comprise or consist essentially of biochar particles. The protective agent can comprise or consist essentially of activated carbon. The protective agent can comprise or consist essentially of charcoal. As used in the context of the present disclosure, the term “consist essentially of” when used in combination with the term “protective agent” indicates that the latter can include additional components but that those additional components are not carbon-containing material.

As it is known in the art, “biochar” is a carbonized form of a plant-derived material (i.e., derived from cellulosic biomass or vegetation) that is specifically produced for non-fuel applications. Some particular examples of biomass materials from which the biochar can be derived include, for example, corn stover (e.g., the leaves, husks, stalks, or cobs of corn plants), grasses (e.g., switchgrass, Miscanthus, wheat straw, rice straw, barley straw, alfalfa, bamboo, hemp), sugarcane, hull or shell material (e.g., peanut, rice, and walnut hulls), woodchips, saw dust, coconut shell, paper or wood pulp, food waste, agricultural waste, and forest waste. In an embodiment, the biomass (or starting material) may be obtained from a softwood (e.g., a pine tree) or a hardwood (e.g., and oak tree). Biochar typically results from the controlled pyrolysis of biomass, where base material is of particle sizes ranging from a few millimeters to several centimeters, although it can also be manufactured using hydrothermal, high pressure and high temperature water processing of biomass. Biochar, which is porous, is composed of mainly carbon (about 30 to 100% or about 60 to 100%) but can also include nitrogen, potassium and calcium. The composition of biochar depends on the feedstock used and the duration and temperature of pyrolysis. The molecular structure and elemental composition makes biochar highly recalcitrant against microbial decomposition. The primary biochar applications are known as an energy generation byproduct resource; for use in carbon sequestration; as a soil amendment; and as a carbonaceous substrate for water treatment.

In an embodiment, the protective agent of the present disclosure can be treated. When the protective agent is “treated” or undergoes “treatment,” it shall mean raw, pyrolyzed carbon-rich mixture that has undergone additional physical, biological, and/or chemical processing by any well-known process in the art.

The protective agent of the present disclosure may have a mean particle size of about 5 to 1500 microns, or about 10 to about 1000 microns, or about 10 to 500, 10 to 200, 10 to 100, 100 to 500, 200 to 500, 50 to 500 or 50 to 300 microns, e.g. at least 10, 20, 30, 40, 50, 60, 70, 80, 90, 100, 150, 200, 250, 300, 350, 400, 450, 500, 600, 700, 800, 900 or 1000 microns. In an embodiment, the mean particle size is between 10 to 300 microns. The person skilled in the art will choose the appropriate particle size in accordance with the specific need in the specific case.

In an embodiment, the protective agent of the present disclosure has a volatile content matter of no greater than about 30% by weight, about 25% by weight, about 20% by weight, about 15% by weight or about 10% by weight. In an embodiment, the protective agent of the present disclosure has a volatile content matter of no greater than 20% by weight.

In an embodiment, the protective agent of the present disclosure has an ash content of less than about 10% by weight, less than about 9% by weight, less than about 8% by weight, less than about 7% by weight, less than about 6% by weight, less than about 5% by weight, less than about 4% by weight, less than about 3% by weight, less than about 2% by weight or less than about 1% by weight. In an embodiment, the protective agent of the present disclosure has an ash content of less than about 8% by weight.

The protective agent can be added to a medium, which can be liquid or a solid substrate. In a specific embodiment, the protective agent can be added to a liquid medium (such as, for example, a liquid inoculant or a liquid fermentation medium). In some embodiments, the protective agent can be (directly) added to a medium capable of supporting the growth of the population of microorganisms, for example in a fermentation mixture (e.g., directly to a liquid nutrient media or a solid substrate) or a fermented culture. In other embodiments, the protective agent can be (directly) added to a liquid inoculant, for example, to a liquid intended to contact a seed or a bulk starter of the microorganisms to be grown. In embodiments in which the protective agent supplements the medium capable of supporting the growth of the population of microorganisms, feeding of the protective agent for promoting yield, growth or increasing the growth rate of the microorganisms to the fermentation media (e.g., culture media or liquid nutrient media) can be included at any stage during the fermentation/culture process, e.g. prior to the fermentation, at the beginning of the fermentation, early-log phase, mid-log phase, late-log phase or stationary phase. In an embodiment, the protective agent can be added to the fermentation/culture media at the beginning of the fermentation, between the early-log phase and the late-log phase or at the stationary phase. As used herein, the term “fermentation” refers to a process of propagating or cultivating a microorganism under aerobic or anaerobic conditions. The fermentation medium in which the microorganisms are introduced can be solid or liquid. In some embodiments, the fermentation medium can be any liquid nutrient media known to those skilled in the art to be compatible with the microorganisms chosen. Alternatively, the fermentation medium can be any solid media or solid substrate known to those skilled in the art to be compatible with the microorganisms chosen. The “stationary phase” is defined as the phase that occurs after the log phase and as the phase in which bacterial growth has essentially ceased. As used herein, the substance containing the microorganisms that are incubated to the substantially stationary phase is termed a “liquid inoculant”, an “inoculant”, a “microbial inoculant immobilized on a solid substrate” or “microbial suspension”.

Generally, the microorganisms can be incubated, fermented or cultured for a period between about 1 to about 10 days. More specifically, the incubation/fermentation/culture period can be between about 1 to about 5 days. During the incubation/fermentation/culture period the medium and the population of microorganisms can be aerated and maintained at a temperature and pH suitable for growth. The precise conditions for incubation/fermentation/culture depend on the type of microorganisms and the type of liquid nutrient media or solid substrate used and is well known to those skilled in the art. For example, Bradyrhizobium elkanii can be incubated on a nutrient media in a shaking incubator for about 4-5 days at temperatures from about 20° C. to about 28° C. Preferably, B. elkanii is incubated for about 3-4 days at about 28° C. to allow the bacteria to grow. The microorganism viability count at the stationary phase varies depending on the microorganisms. For example, cell counts in the liquid inoculant could be from about 1×10⁸ CFU/ml to about 1×10¹¹ CFU/ml. More particularly, the liquid inoculant can comprise about 1×10¹⁰ CFU/ml. These amounts are provided as exemplary amounts, and as such other amounts are contemplated to be within the scope of the present disclosure. As mentioned, the agent for promoting or increasing the growth, growth rate and/or survival rate of the microorganisms can be directly added at any step of the fermentation process.

In another example, a solid substrate or a solid growth medium can be contemplated in the context of the present disclosure. Examples of fungi that can be cultivated and inoculated on solid growth medium comprises species of the genera Piriformospora, Phlebiopsis, Clonostachys, Nectria, Chondrostereum, Pseudozyma, Coniothyrium, Trichoderma, Metarhizium, Verticillium, Penicillium, Aspergillus, Isaria or Beauveria. In an embodiment, the fungi are Piriformospora indica, Phlebiopsis gigantea, Clonostachys sp., Nectria pityrodes, Chondrostereum purpureum, Pseudozyma flocculosa, Coniothyrium minitans, Trichoderma harzianum, sp., Metarhizium sp., Verticillium sp., Penicillium sp., Aspergillus sp. or Beauveria bassiana. As known in the art, bacteria can also be grown on a solid growth medium and can be, for example, species of Streptomyces sp., Bacillus sp. or Pseudomonas sp. It is known in the art that solid growth medium comprising various organic or inorganic carriers can be used. For example, inorganic carriers such as vermiculite, perlite, amorphous silica or granular clay can be used. These types of materials are commonly used because they form loose, airy granular structure having a high surface area. Examples of organic carriers that can be used are cereal grains, bran, corncob, sawdust, peat or wood chips. In addition, the solid growth medium may contain supplemental nutrients for the microorganism. Typically, these include carbon sources such as carbohydrates (sugars, starch), proteins or fats, nitrogen sources in organic form (proteins, amino acids) or inorganic nitrogen salts (ammonium and nitrate salts, urea), trace elements or other growth factors (vitamins, pH regulators). The solid growth medium may contain aids for structural composition, such as absorbents, for example polyacrylamides. After inoculation with an inoculum of a liquid or solid form, the inoculated solid growth medium is incubated at temperatures from about 20° C. to about 35° C. for about 4 to 15 days. The precise conditions for incubation/fermentation/culture depend on the type of microorganisms and the type of solid substrate used and is well known to those skilled in the art. As mentioned, the agent for promoting or increasing the growth, growth rate and/or survival rate of the microorganisms can be directly added at any step of the process.

In a further embodiment, after the stationary phase is attained, the protective agent can be introduced to the medium, the liquid inoculant or microbial suspension in order to maintain and/or increase the viability and stability of the microorganisms during their storage before and after final packaging. The protective agent can be added to the medium, the liquid inoculant or microbial suspension while it is still in the vessel used during fermentation or incubation (e.g., fermentation reactor or shaking incubator). Alternatively, the protective agent can be added to the medium, the liquid inoculant or microbial suspension in separate before or directly during packaging. After packaging, the medium, the inoculant composition or microbial suspension can be stored. The storage conditions can include refrigerated to ambient temperatures and low to moderate or high relative humidity. Preferably, storage conditions include a temperature below about 35° C. and a relative humidity below about 80%.

The medium, liquid inoculant or microbial suspension along with the protective agent can also be applied to a variety of seeds. For example, the liquid inoculant or microbial suspension along with biochar can be applied to seeds for leguminous plants such as soybean, alfalfa (lucerne), peanut, pea, lentil, bean, clover and the like. The medium, liquid inoculant or microbial suspension along with the protective agent can also be applied to non-leguminous crops including, but not limited to, field crops such as corn, cereals (such as wheat, barley, rye, sorghum, millet or rice), cotton, and canola, and fruits and vegetable crops such as potatoes, tomatoes, cucurbits, onions, beets, lettuce, radish and the like are also suitably treated. The medium, liquid inoculant or microbial suspension along with protective agent can be applied or coated onto the surface of a seed of a plant either alone or in combination with any known agriculturally acceptable, non-interfering carrier according to any suitable methods known in the art. In another embodiment, the “liquid inoculant”, “inoculant”, “microbial inoculant immobilized on a solid substrate” or “microbial suspension” can be coated on fertilizers or any agriculturally acceptable additives.

The protective agent can be added to the nutrient media (at any stage of the fermentation), to the solid substrate, to the liquid inoculant or to the microbial suspension in a concentration from about 0.01% to about 50% by weight/volume of the nutrient media (at any stage of the fermentation), to the liquid inoculant or to the microbial suspension. For example, from about 0.05% to 20%, about 0.1% to 15%, about 0.5% to 10% or about 1% to 5% by weight/volume of the protective agent can be used. In another embodiment, the protective agent can be used in a concentration of at least about 0.01%, 0.05%, 0.1%, 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 11%, 12%, 13%, 14%, 15%, 16%, 17%, 18%, 19%, 20%, 25%, 30%, 35%, 40%, 45% or 50% by weight/volume of nutrient media (at any stage of the fermentation), to the liquid inoculant or to the microbial suspension. In an embodiment, the protective agent can be added to the nutrient media (at any stage of the fermentation), to the solid substrate, to the liquid inoculant or to the microbial suspension in a concentration from about 0.01% to about 10% by weight/volume.

Any suitable agriculturally acceptable carrier may also be used in conjunction with the medium, liquid inoculant or microbial suspension comprising the protective agent. For example, a solid carrier, semi-solid carrier, an aqueous-based liquid carrier, a non-aqueous based liquid carrier, a suspension, an emulsion or an emulsifiable concentrate may be used in conjunction with the medium, liquid inoculant or microbial suspension comprising the protective agent. Agriculturally-acceptable carriers may include, e.g., adjuvants, inert components, dispersants, surfactants, tackifiers, binders, stabilizing agents, and/or polymers. Other additives may also be used in conjunction with the present disclosure. Such additives include, but are not limited to, UV-protectants, colorants, brighteners, pigments, dyes, extenders, dispersing agents, excipients, anti-freeze agents, herbicidal safeners, seed safeners, seed conditioners, micronutrients, fertilizers, surfactants, sequestering agents, plasticizers, polymers, emulsifiers, flow agents, coalescing agents, defoaming agents, humectants, thickeners, and waxes. Such additives are commercially available and known in the art.

Alternatively, in another embodiment, a physiologically acceptable carrier may be used in conjunction with the medium, liquid inoculant or microbial suspension comprising the protective agent. The physiologically acceptable carrier can be a food product or a pharmaceutical carrier which are well known in the art.

The word “comprising” in the claims may be replaced by “consisting essentially of” or with “consisting of,” according to standard practice in patent law.

The present invention will be more readily understood by referring to the following examples which are given to illustrate the invention rather than to limit its scope.

### Example 1—Effect of Biochar on the Growth of Bradyrhizobium elkanii

This study aimed to determine the influence of biochar on bacterial yield during fermentation. The present experiment was conducted using B. elkanii strains SEMIA 587 and SEMIA 5019 (FEPAGRO-Fundação Estadual de Pesquisa Agropecuária, Rua Gonçalves Dias, 570, Bairro Menino Deus, Porto Alegre/RS, Brazil). The strains of B. elkanii were cultured separately in four different media having the following composition:

TABLE 1
Fermentation medium composition (g/L)

| | | M1 | | M2 |
|---|---|---|---|---|
| | | supplemented | | supplemented |
| Component | M1 | with biochar | M2 | with biochar |
| NaCl | — | — | 0.1 | 0.1 |
| MgSO₄ | — | — | 1 | 1 |
| K₂PO₄ | — | — | 0.87 | 0.87 |
| KH₂PO₄ | — | — | 0.31 | 0.31 |
| Yeast extract | 2 | 2 | 4 | 4 |
| D-mannitol | — | — | 10 | 10 |
| Glycine betaine | 0.012 | 0.012 | — | — |
| Sodium Gluconate | 1 | 1 | — | — |
| CaCl₂*2H₂O | 0.5 | 0.5 | — | — |
| Tryptone | 5 | 5 | — | — |
| Glycerol | 20 | 20 | — | — |
| Biochar (particle size | — | 5 | — | 5 |
| 210 μm = 70 mesh; | | | | |
| starting material: soft | | | | |
| wood/pine; 1% ash | | | | |
| (dry weight basis); | | | | |
| 19.1% volatile matter | | | | |
| (VM)) | | | | |
| Trace elements | 1 ml | 1 ml | — | — |

For the preparation of the cultures, 100 ml of each culture medium was inoculated with 3 ml of glycerol stock culture of each strain and incubated for 96 hours at 28° C. at an agitation speed of 180 rpm. After 48 h, 72 h and 96 hours of growth, aliquots from the culture media without biochar were removed to measure the optical density at 600 nm, the number of viable bacteria and the final pH. For the culture media comprising biochar, at each time point an aliquot of each sample was used to prepare a set of dilution tubes 10⁻¹ to 10⁻⁸. One hundred μl of the highest 2 dilutions were then plated on the appropriate media and incubated 2-5 days at 28° C. before enumeration.

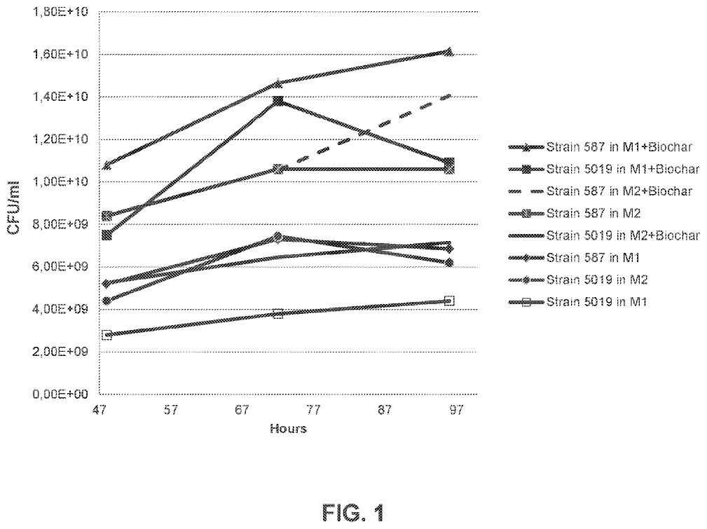

As shown in FIG. 1, these results demonstrated that a greater biomass and cell stability are achieved when the B. elkanii strains SEMIA 587 and SEMIA 5019 were cultured in the presence of biochar. More particularly, it was observed that the presence of biochar increased the growth rate of B. elkanii strains SEMIA 587 and SEMIA 5019 by at least 237% and 248%, respectively, as compared to the growth rate of the same strains grown in the absence of biochar particles.

### Example 2—Influence of Biochar on the Stability Behavior and Shelf Life of Rhizobium leguminosarum

The purpose of this experiment was to study the influence of the biochar on the cell stability behavior and survival rate of R. leguminosarum during storage at room temperature. The present experiment was conducted using the commercial R. leguminosarum strain INRA P221 and strain INRA P1NP1J (Institut National de la Recherche Agronomique, France). R. leguminosarum strain INRA P221 and strain INRA P1NP1J were cultured in a medium having the following composition:

TABLE 2
Fermentation medium composition

| Component | g/L |
|---|---|
| Mannitol | 10 |
| Yeast extract | 1 |
| MgSO₄*7H₂O | 0.2 |
| NaCl | 0.1 |
| K₂HPO₄ | 0.87 |
| KH₂PO₄ | 0.31 |

For the preparation of the pre-cultures, 100 ml of culture medium was inoculated with 3 ml of a glycerol stock culture and incubated for 24 hours at 28° C. at an agitation speed of 180 rpm.

The co-fermentation of the strains was performed in 2 L fermenters with aeration at 28° C. using 3% (w/w) of the culture mentioned above as inoculum. Agitation was 180 rpm. The pH was maintained at 7.0 by controlled addition of 2 N H2SO4 or 1 N NaOH. The yields of the fermentations were specified by the obtained bacteria biomass measured by optical density at 600 nm. Fermentation results represent the mean of four replicates.

To improve the survival of the strains during the storage, a protective agent was added before packaging. The bacterial count was determined before the addition of the protective agent at the beginning of the storage and was about 3.70×10⁹ CFU/ml.

The following treatments were selected for this study: (a) R. leguminosarum strains alone (negative control); (b) protective agent comprising 0.6% polyvinylpyrrolidone (PVP) and 0.1% phosphate buffer at a ratio of bacteria:polymer protective agent of 1:1 (volume:volume); and (c) protective agent comprising 1% biochar (particle size 210 microns=70 mesh; starting material: soft wood/pine; 1% ash (dry weight basis); 19.1% volatile matter (VM))) and 0.1% phosphate buffer at a ratio of bacteria:biochar of ratio 1:1 (volume:volume).

For each preparation (i.e. each treatment), the culture of R. leguminosarum was added to a protective agent (i.e. a protective agent comprising polymer (PVP) and a protective agent comprising biochar) in a ratio mentioned above. The resulting products were stored in the dark at room temperature (i.e. 22° C.) for 131 days. The viable cell counts and pH level were determined on day 0, 35, 60, 91 and 131. At each particular time point, one aliquot of each sample was used to prepare a set of dilution tubes 10⁻¹ to 10⁻⁸. One hundred μl of the highest 2 dilutions were then plated on the appropriate media and incubated 2-5 days at 28° C. before enumeration.

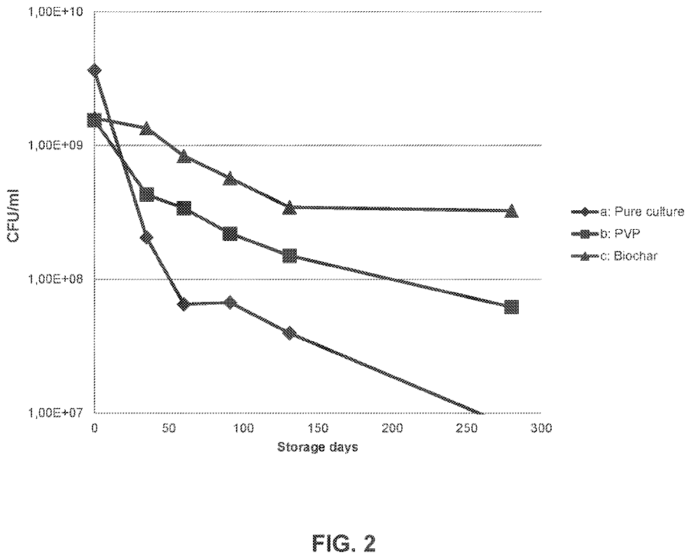

The viability of R. leguminosarum strains after storage at room temperature in combination with a protective agent is shown in FIG. 2. The results show a particularly marked effect of biochar on survival of the R. leguminosarum during storage. Indeed, for the long term preservation, results demonstrated that protective agent comprising biochar was the most efficient in maintaining microbial viability. One hundred thirty-one days after storage, the viability count of R. leguminosarum was 8.7 times higher in the storage media supplemented with biochar than the in the control product. The results of this study also indicated that biochar is more effective than a protective agent comprising polymer in protecting R. leguminosarum strains. This protective agent comprising PVP was already known to allow an increase in the shelf life of R. leguminosarum strains.

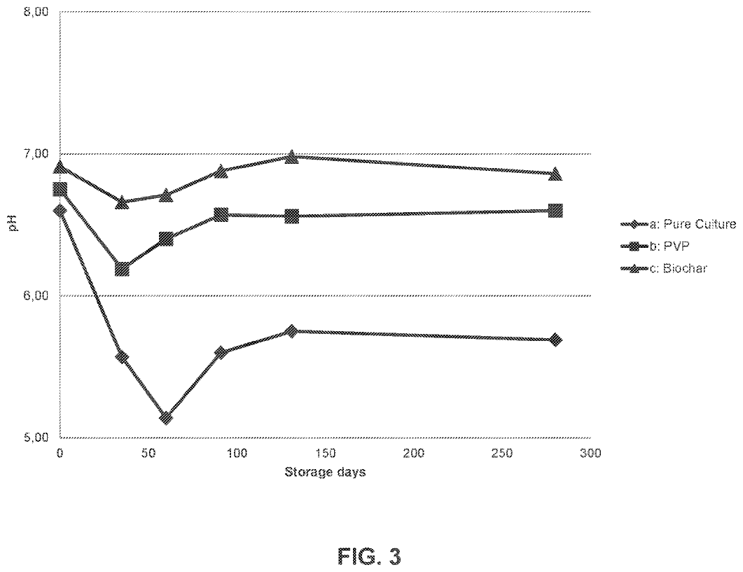

As illustrated in FIG. 3, the pH value evolved in different profiles depending on the storage medium. It may be noted that when the bacterial cells were in the presence of biochar, the pH did not vary greatly and remained stable around a value of approximately 7.0. In contrast, in the case of the pure culture of bacterial cells, the pH was markedly lower.

### Example 3—Influence of Biochar on the Stability Behavior and Shelf Life of Delftia acidovorans

This study evaluated the influence of biochar on the growth and survival rate of Delftia acidovorans during fermentation and storage at room temperature. The present experiment was conducted using the D. acidovorans strain Ray 209 (deposited at ATCC under number PTA-4249). For the preparation of the pre-culture, 100 ml of culture medium TSB was inoculated with 2 ml of a glycerol stock culture and incubated for 24 hours at 28° C. at an agitation speed of 180 rpm. D. acidovorans strain Ray 209 was cultured in four different media having the following composition:

TABLE 3
Fermentation medium composition (g/L)

| | | | | F4: |
|---|---|---|---|---|
| | | | F3: | Delftia |
| | | F2: | Delftia | medium |
| | | Delftia | medium | supple- |
| | | medium | supple- | mented |
| | | supple- | mented | with |
| | F1: | mented | with | biochar and |
| | Delftia | with | phosphate | phosphate |
| Component | medium | biochar | buffer | buffer |
| Glycerol | 20 | 20 | 20 | 20 |
| Tryptone | 5 | 5 | 5 | 5 |
| Yeast extract | 3 | 3 | 3 | 3 |
| Trace elements | Less | Less | Less | Less |
| | than 0.1% | than 0.1% | than 0.1% | than 0.1% |
| | w/v of each | w/v of each | w/v of each | w/v of each |
| Biochar | — | 5 | — | 5 |
| (particle size | | | | |
| 210 μm = 70 | | | | |
| mesh; starting | | | | |
| material: soft | | | | |
| wood/pine; 1% | | | | |
| ash (dry weight | | | | |
| basis); 19.1% | | | | |
| volatile matter | | | | |
| (VM)) | | | | |
| K₂HPO₄ | — | — | 0.87 | 0.87 |
| KH₂PO₄ | — | — | 0.31 | 0.31 |

Four different fermentations were performed in 2 L fermenters using medium F1, F2, F3 and F4 with aeration at 28° C. using 2% (w/w) of the culture mentioned above as inoculum. Agitation was 180 rpm. The pH was maintained at 7.0, only for medium F1 and F3, by controlled addition of 2N H₂SO₄ or 1 N NaOH. The yields of the fermentations were specified by the obtained biomass measured by optical density at 600 nm.

To improve the survival of the strain during the storage, a protective agent was added before packaging. The bacterial count was determined before the addition of the protective agent at the beginning of the storage. The following treatments/storage media were selected for this study: (a) protective agent comprising 0.15% sodium carboxymethylcellulose (CMC) and 9% trehalose at a ratio of bacteria:protective agent of 1:3 (volume:volume); (b) protective agent comprising 0.45% polyvinylpyrrolidone (PVP) and 0.1% phosphate buffer at a ratio of bacteria:polymer protective agent of 1:3 (volume: volume) and (c) a protective agent comprising 0.5% biochar (particle size 210 μm=70 mesh) and 0.1% phosphate buffer at a ratio of bacteria:protective agent of 1:3 (volume:volume).

For each preparation (i.e. each treatment), 0.87 L of culture broth of D acidovorans was added to 1.73 L of each storage medium (ratio 1:3). The resulting products were stored at room temperature (at 21° C.) in the dark for 124 days. The viable cell counts and pH level were determined on day 0, 30, 75 and 124. At each time point an aliquot of each sample was used to prepare a set of dilution tubes 10⁻¹ to 10⁻⁸. One hundred μl of the highest 2 dilutions were then plated on the appropriate media and incubated 2-5 days at 28° C. before enumeration.

As shown in Table 4, it is observed that the presence of biochar increased the growth rate of D. acidovorans strain after 24 hours of growth.

TABLE 4
Growth expressed as viability counts in CFU/ml of D. acidovorans
after culturing with or without biochar.

| Medium composition | Viability count after 24 | |
|---|---|---|
| (see Table 3) | hours of growth | |
| F1 | 9.3 × 10⁸ | CFU/ml |
| F2 - with biochar | 2.5 × 10⁹ | CFU/ml |
| F3 | 1.6 × 10⁹ | CFU/ml |
| F4 - with biochar | 2.25 × 10⁹ | CFU/ml |

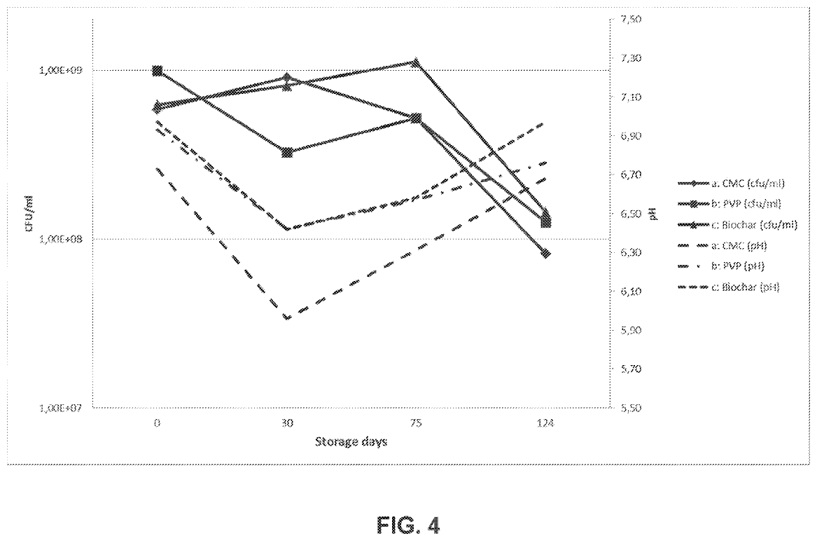

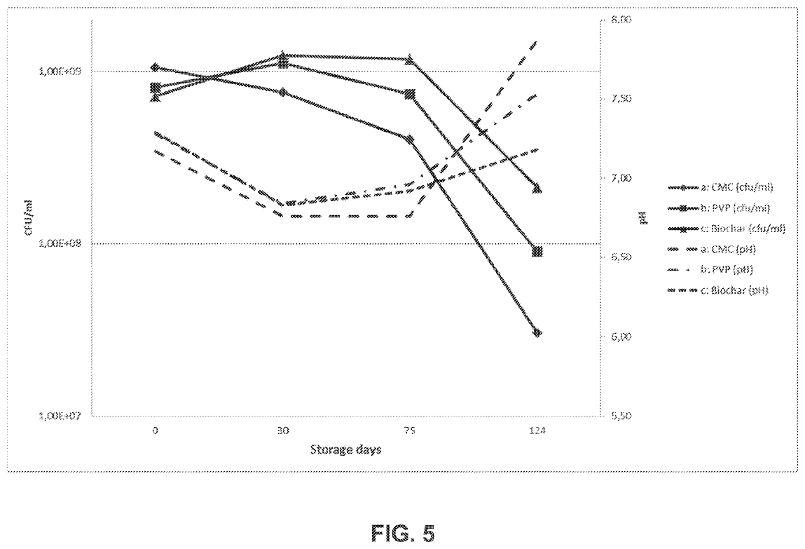

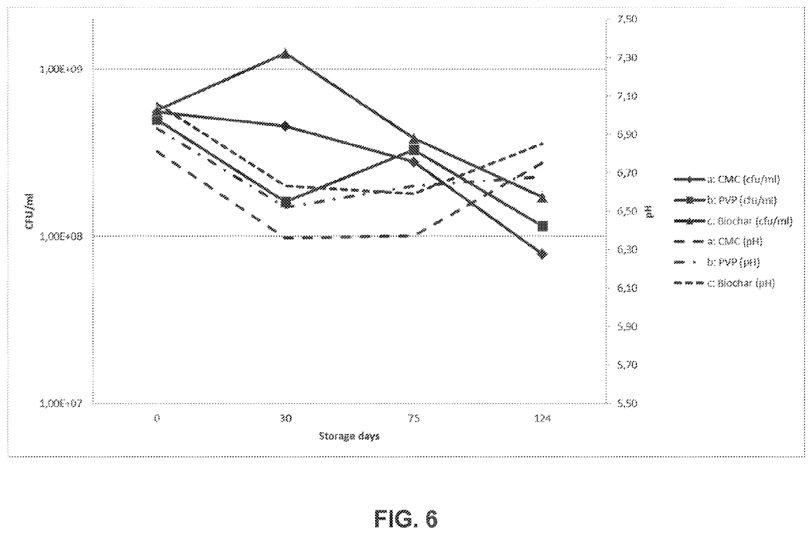

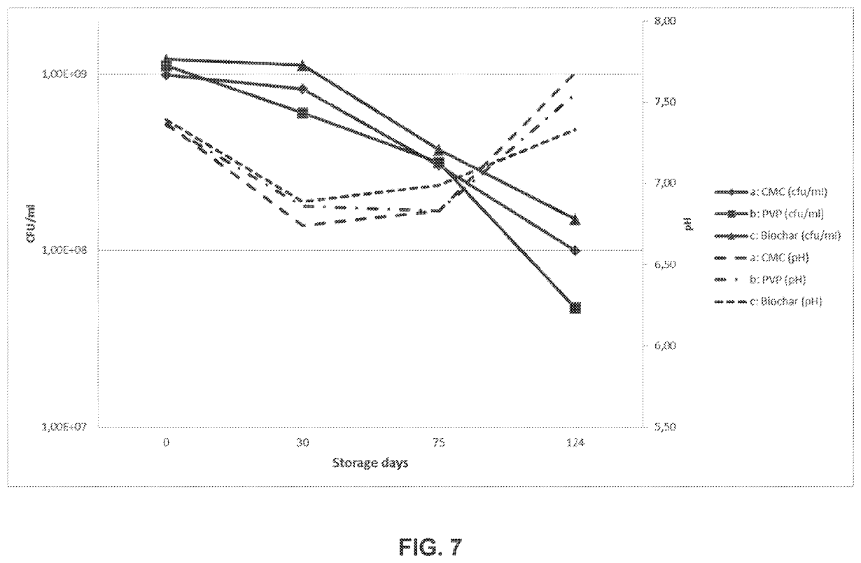

The results of this study revealed, as shown in FIGS. 4 to 7, that the survival rate of D. acidovorans was increased with the presence of biochar. This increased viability is observed even though the bacteria were cultured in the absence of biochar in the fermentation medium (FIGS. 4 and 7).

### Example 4—Effect of Biochar on the Growth of Azospirillum brasilense

This study aimed to determine the influence of biochar on bacterial yield during fermentation. The present experiment was conducted using a commercial strain of Azospirillum brasilense (Azos®, Lallemand Plant Care). The strain of A. brasilense was cultured in two different media having the following composition:

TABLE 5
Fermentation medium composition (g/L) for A. brasilense

| | | Azospirillum media |
|---|---|---|
| | Azospirillum | supplemented with |
| Component | media | biochar |
| Phosphate buffer | 1 | 1 |
| Yeast extract | 5 | 5 |
| Tryptone | 5 | 5 |
| Glycerol | 8 | 8 |
| Biochar (starting | — | 10 |
| material: pine; 7% | | |
| VM; 4.5% Ash; D50: | | |
| 30.3 um) | | |
| Trace elements | 1 ml | 1 ml |

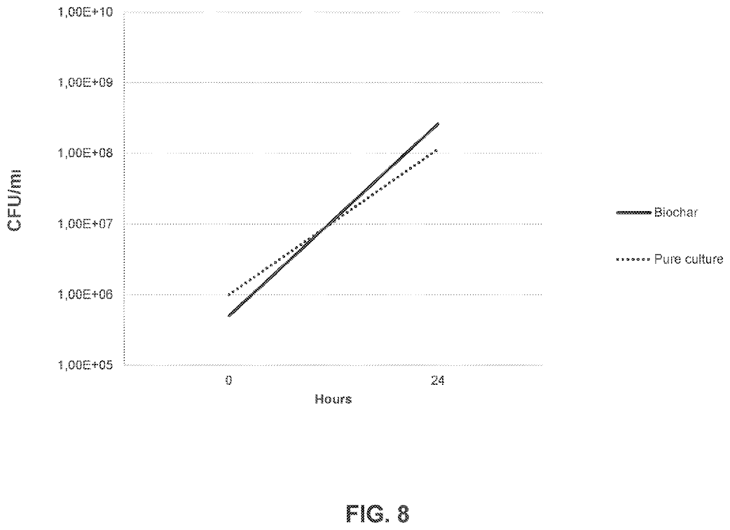

The strain of A. brasilense was grown in a medium in absence or presence of biochar in an aerated 250 ml flask, at 28° C. After 24 hours of growth, aliquots from the culture media were removed to measure the optical density at 600 nm and the number of viable bacteria. An aliquot of each sample was used for enumeration as described in Example 1. As shown in FIG. 8, a greater biomass was achieved when the A. brasilense strain was cultured in the presence of biochar.

### Example 5—Influence of Biochar on the Stability and Shelf Life of Herbaspirillum spp.

This study evaluated the influence of biochar on the cell stability and survival rate of Herbaspirillum spp during fermentation and storage at room temperature. The present experiment was conducted using a commercial strain of Herbaspirillum huttiense (Endo-Rice, Lallemand Plant Care). The strain of Herbaspirillum spp. was cultured in a medium having the following composition:

TABLE 6
Fermentation medium composition (g/L) for Herbaspirillum spp.

| Component | Herbaspirillum media |
|---|---|
| Phosphate buffer | 1 |
| Yeast extract | 5 |
| Glycerol | 8 |
| Trace elements | 1 ml |

Herbaspirillum spp was grown in a medium in a 2 L fermenter with aeration at 28° C. using 3% (w/w) of a pre-culture as inoculum (concentration 2.05×10⁹ CFU/ml). The pH was maintained at 7.0 by controlled addition of 2 N H₂SO₄ or 1 N NaOH. The fermentation yields were specified by the obtained biomass measured by optical density at 600 nm.

To improve the survival of the commercial strain of Herbaspirillum spp during the storage, a protective agent comprising biochar was added before packaging. The bacterial count was determined before the addition of the protective agent at the beginning of the storage (8.1×10⁸ CFU/ml). The following treatments were selected for this study: (a) strain alone (negative control); (b) 0.1% phosphate buffer (pH 7) at a ratio of bacteria:phosphate buffer of 1:1 (volume:volume); and (c) protective agent comprising 1% biochar (starting material: pine; 7% VM; 4.5% Ash; D50: 30.3 um) in a 0.1% phosphate buffer (pH 7) at a ratio of bacteria:biochar suspension 1:3 (volume:volume).

The resulting products were stored in the dark at room temperature (i.e. 21° C.). The viable cell counts and pH level were determined on day 0, 11 and 45. At each particular time point, one aliquot of each sample was used for enumeration as described in Example 1.

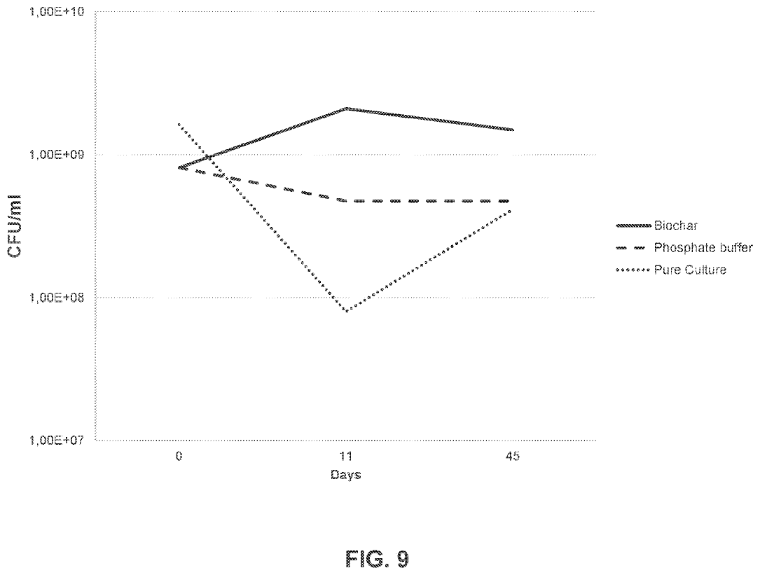

The results of this study revealed, as shown in FIG. 9, that the survival rate of the Herbaspirillum spp was increased dramatically with the presence of biochar.

### Example 6—Influence of Biochar on the Stability and Shelf Life of Delftia acidovorans

The purpose of this experiment was to study the influence of the biochar on the cell stability behavior and survival rate of a strain of Delftia acidovorans during storage at room temperature. The present experiment was conducted using a strain of Delftia acidovorans RAY209 (deposited at ATCC under number PTA-4249). D. acidovorans was grown in a medium having the following composition:

TABLE 7
Fermentation medium composition (g/L) for D. acidovorans

| Component | Culture media |
|---|---|
| Yeast extract | 3 |
| Tryptone | 6 |
| Glycerol | 15 |
| Trace elements | 1 ml |

D. acidovorans was grown in a 2 L fermenter with aeration at 28° C. using 3% (w/w) of a pre-culture as inoculum (concentration 2.0×10⁹ CFU/ml). The pH was maintained at 6.8 by controlled addition of 2 N H₂SO₄ or 1 N NaOH. The fermentation yields were specified by the obtained biomass measured by optical density at 600 nm. To improve the viability and stability of D. acidovorans during the storage, a protective agent was added before packaging. The bacterial count was determined before the addition of the protective agent at the beginning of the storage.

The following treatments were selected for this study: (a) pure culture alone; (b) protective agent comprising 0.1% phosphate buffer (pH 7) at a ratio of bacteria:phosphate buffer of 1:3 (volume:volume); and (c) protective agent comprising 0.75% biochar (starting material: pine; 7% VM; 4.5% Ash; D50: 30.3 um) in a 0.1% phosphate buffer at a ratio of bacteria:biochar of ratio 1:3 (volume:volume). The bacterial counts, determined before the addition of the protective agent at the beginning of the storage, were 5.9×10⁸ CFU/ml, 7.3×10⁸ CFU/ml and 5.8×10⁸ CFU/ml, respectively. The resulting products were stored in the dark at room temperature (i.e. 21° C.). The viable cell counts were determined on day 1, 48, 93, 135 and 185. At each particular time point, one aliquot of each sample was used for enumeration as described in Example 1.

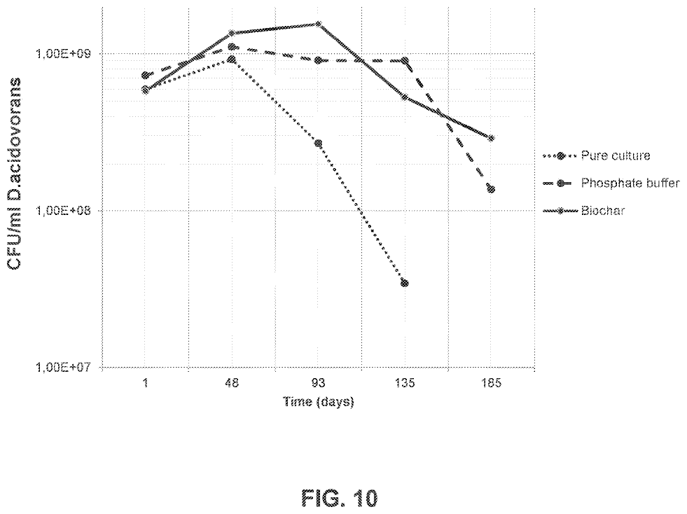

The viability of D. acidovorans after storage at room temperature in combination with biochar is shown in FIG. 10. The results show a marked effect of biochar on survival of the D. acidovorans during storage. Indeed, for the long term storage, results demonstrated that protective agent comprising biochar was the most efficient in maintaining microbial viability.

### Example 7—Influence of Different Concentrations of Biochar on the Stability and Shelf Life of Rhizobium leguminosarum

The purpose of this experiment was to study the influence of the different concentrations of biochar on the cell stability behavior and survival rate of R. leguminosarum strain INRA P221 and strain INRA P1NP1J during storage at room temperature. The fermentation of the strains was performed as described in Example 2. To test the survival of the strains during the storage, biochar at different concentrations was added before packaging. The biochar included in the study had the following characteristics: starting material: pine; 4% VM (volatile matter); 4% Ash; D50: 11.1 um. The following treatments were included in the study: (a) R. leguminosarum strains alone (control); (b) Biochar 1 g/L; (c) Biochar 5 g/L; and (d) Biochar 10 g/L. The bacterial count, determined before the addition of the protective agent at the beginning of the storage, were 3.6×10⁹ CFU/ml (treatment (a)) and 1.4×10⁹ CFU/ml (treatments (b) to (d)). The resulting products were stored in the dark at room temperature (i.e. 21° C.) for 133 days. The viable cell counts were determined on day 0, 20, 95 and 133. At each particular time point, one aliquot of each sample was used for enumeration as described in Example 1.

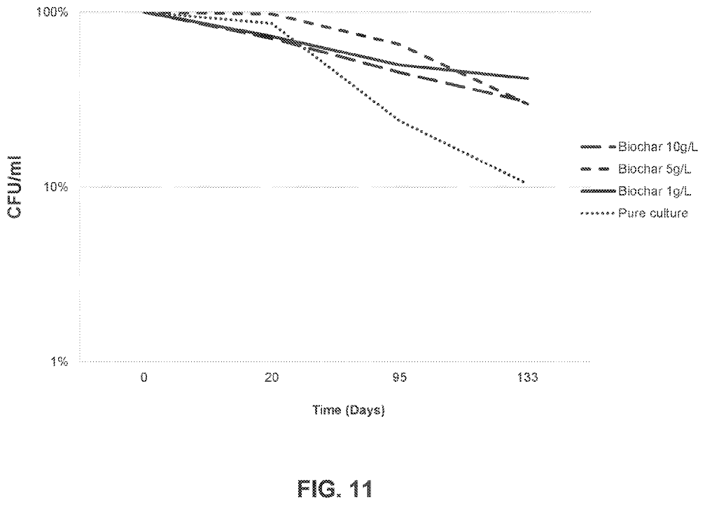

The viability of R. leguminosarum strains after storage at room temperature in combination with biochar at different concentrations is shown in FIG. 11. The results show that the percent recovery, viability or stability of R. leguminosarum was greater when biochar was included during storage.

### Example 8—Effect of Biochar on the Growth of Rhizobium leguminosarum

This study aimed to determine the influence of biochar on bacterial yield during fermentation. The present experiment was conducted using R. leguminosarum strain INRA P221 and strain INRA P1NP1J. The strains were cultured separately in three different media having the following compositions:

TABLE 8
Fermentation medium composition (g/L)

| Component | T1 | T2 | T3 |
|---|---|---|---|
| Mannitol | 10 | 10 | 10 |
| Yeast extract | 2 | 2 | 2 |
| NaCl | 0.5 | 0.5 | 0.5 |
| Biochar (starting | — | 1 | 5 |
| material: pine; | | | |
| 7% VM; 4.5% | | | |
| Ash; D50: 30.3 um) | | | |
| Trace elements | 1 ml | 1 ml | 1 ml |

For the preparation of the cultures, 100 ml of each culture medium was inoculated with 3 ml of glycerol stock culture of each strain and incubated with aeration for 96 hours at 28° C. After 48 h, 72 h and 96 hours, aliquots from the culture media with and without biochar were removed to measure the optical density at 600 nm and the number of viable bacteria as described in Example 1.

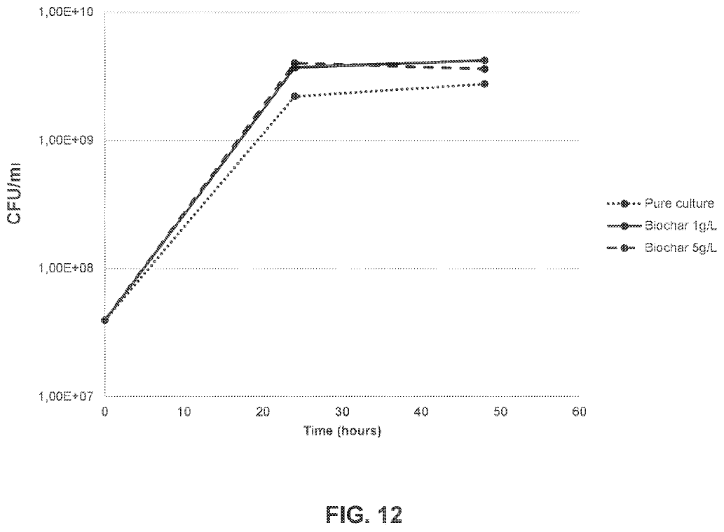

As shown in FIG. 12, these results demonstrated that a greater biomass was achieved when R. leguminosarum is cultivated in the presence of biochar.

### Example 9—Effect of Activated Carbon on the Growth of Bradyrhizobium elkanii

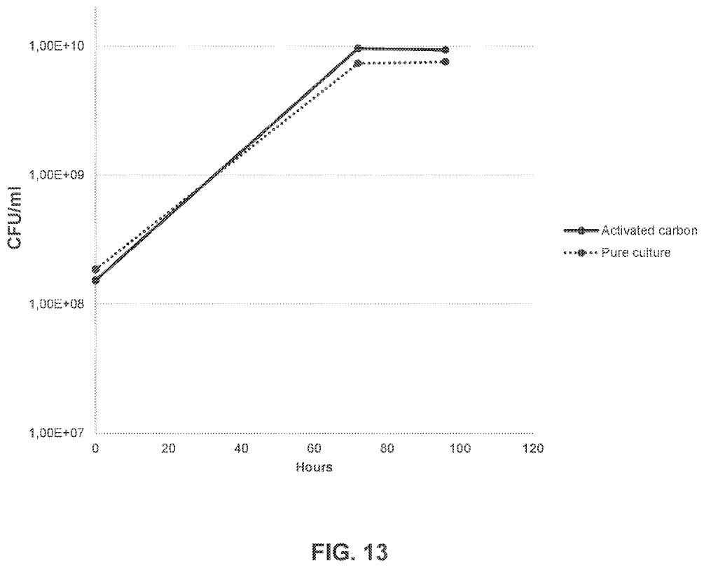

This study aimed to determine the influence of activated carbon on bacterial yield during fermentation. The present experiment was conducted using B. elkanii strains SEMIA 587 and SEMIA 5019. The strains of B. elkanii were cultured as described in Example 1 (in absence of biochar). Activated carbon (Sigma: Cat #161551 CAS: 7440-44-0; 100 mesh) was included at a concentration of 5 g/L. The bacterial enumeration was also done in accordance with Example 1. As shown in FIG. 13, results demonstrated that a greater viability was achieved when B. elkanii is cultivated in the presence of activated carbon.

### Example 10—Influence of Different Concentrations of Activated Carbon on the Stability and Shelf Life of Bradyrhizobium elkanii

This study aimed to determine the influence of activated carbon on bacterial stability during storage. The present experiment was conducted using the B. elkanii strains SEMIA 587 and SEMIA 5019. The strains were cultured separately in three different media having the following compositions:

TABLE 9
Fermentation medium composition (g/L)

| Component | T1 | T2 | T3 |
|---|---|---|---|
| Tryptone | 5 | 5 | 5 |
| Yeast extract | 2 | 2 | 2 |
| Activated carbon | — | 0.5 | 5 |
| (Sigma: Cat#161551 | | | |
| CAS: 7440-44-0; | | | |
| 100 mesh) | | | |
| Trace elements | 1 ml | 1 ml | 1 ml |

Following the fermentation, the microbial suspensions comprising or not activated carbon were mixed with a 0.1% phosphate buffer (pH 7) before packaging. The bacterial counts, determined before the addition of the protective agent at the beginning of the storage, were 8.5×10⁹ CFU/ml (T1 and T3); and 9.8×10⁹ CFU/ml (T2). The resulting products were stored in the dark at room temperature (i.e. 21° C.). The viable cell counts were determined on day 0, 8, 44, 93 and 226. At each particular time point, one aliquot of each sample was used for enumeration as described in Example 1.

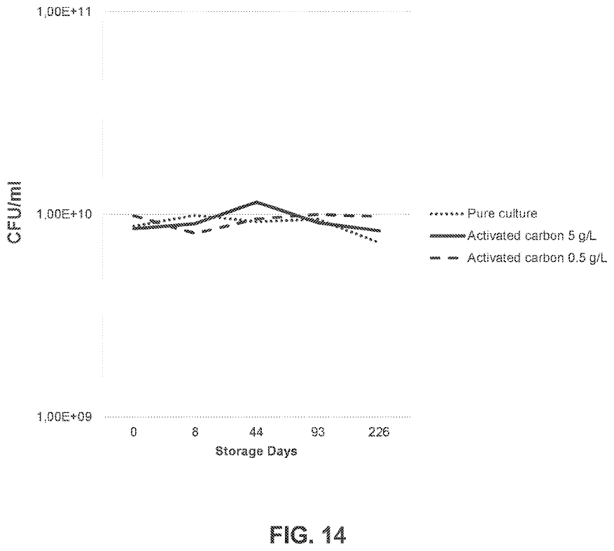

FIG. 14 shows a marked effect of activated carbon on survival of B. elkanii during storage. Indeed, for the long term storage, results demonstrated that protective agent comprising activated carbon was efficient in maintaining microbial viability.

### Example 11—Effect of Biochar on the Growth of Piriformospora spp.

Solid media suitable for Piriformospora indica growth were prepared according to the following composition.

TABLE 10
Media composition for solid state fermentation

| | | |
|---|---|---|
| Component | Medium A | Medium B |

| | | | | |
|---|---|---|---|---|
| Malt extract | 5 | g | 5 | g |
| Yeast extract | 1 | g | 1 | g |
| Water | 60 | ml | 6 | ml |
| Silica | 25 | g | 25 | g |

| | | |
|---|---|---|
| Biochar (particle size | 2.5 | g |
| 210 μm = 70 mesh; | | |
| starting material: soft | | |
| wood/pine; 1% ash (dry | | |
| weight basis); 19.1% | | |
| volatile matter (VM)) | | |

Components of each medium were mixed in a glass beaker and sterilized in an autoclave at 121° C. for 30 minutes. After autoclaving the reactor was let to cool down. The inoculum of Piriformospora sp. was cultivated in shake flasks in a malt-extract solution for 4 days at 22° C. at 170 rpm. The two solid growth media were inoculated with 3 ml of inoculum and mixed aseptically with a sterile spoon. The inoculated media were incubated at 30° C. for 7 days.

After the fungus had grown and sporulated throughout the whole media, the colonized growth media were placed on tissue papers for drying at room temperature. Viable spore count of dried media was quantified as CFU/g. Five repetitions were carried out and the results with biochar were compared with the control with no biochar.

TABLE 11
Growth expressed as viability counts in CFU/g of P. indica after
culturing by solid state fermentation with or without biochar

| Medium A (without biochar) | Medium B (with biochar) |
|---|---|
| 1.42 × 10⁶ | 4.37 × 10⁶ |

As shown in Table 11, the viable spore count was increased by a factor 3 when P. indica was cultured in a solid medium comprising biochar compared with the same solid medium without biochar.

While the invention has been described in connection with specific embodiments thereof, it will be understood that the scope of the claims should not be limited by the preferred embodiments set forth in the examples, but should be given the broadest interpretation consistent with the description as a whole.

### REFERENCES

Hynes R K, Boyetchko S M. Research initiatives in the art and science of biopesticide formulations. Soil Biol Biochem. 2006; 38: 845-849.

What is claimed is:

1. A method for increasing the yield, growth, growth rate, survival rate and/or viability of a population of microorganisms, the method comprising contacting a protective agent comprising biochar particles, activated carbon and/or charcoal with the population of microorganisms to obtain a mixture.

2. The method of claim 1, wherein the protective agent comprises or consists essentially of biochar particles.

3. The method of claim 1, wherein the protective agent comprises or consists essentially of activated carbon.

4. The method of any one of claims 1 to 3, wherein the protective agent is added at a concentration of 0.01% to 50%, 0.05% to 20%, 0.1% to 15%, 0.1% to 10% or 0.1% to 5% weight/volume of the mixture.

5. The method of any one of claims 1 to 4, wherein the mixture further comprises a medium.

6. The method of claim 5, wherein the medium is a liquid medium.

7. The method of claim 6, wherein the mixture is a liquid inoculant.

8. The method of claim 5, wherein the medium is a solid substrate.

9. The method of claim 8, wherein mixture is a microbial inoculant immobilized in the solid substrate.

10. The method of any one of claims 1 to 9 further comprising storing the mixture.

11. The method of any one of claims 1 to 10, wherein the population of microorganisms was grown in the absence of the protective agent.

12. The method of any one of claims 1 to 10, wherein the population of microorganisms was grown in the presence of the protective agent.

13. The method of any one of claims 10 to 12, wherein the presence of the protective agent reduces the loss during storage of the population of microorganisms by 1%, 5%, 10%, 15%, 20%, 25%, 30%, 35%, 40%, 45%, 50%, 55%, 60%, 65%, 70%, 75%, 80%, 90%, 95% or 100% or by no more than 0.1 log CFU, 0.2 log CFU, 0.3 log CFU 0.4 log CFU, 0.5 log CFU, 0.6 log CFU, 0.7 log CFU, 0.8 log CFU, 0.9 log CFU, 1 log CFU, 1.1 log CFU, 1.2 log CFU, 1.3 log CFU, 1.4 log CFU, 1.5 log CFU, 1.6 log CFU, 1.7 log CFU, 1.8 log CFU, 1.9 log CFU or 2 log CFU when compared to a corresponding population of microorganisms in a control mixture which does not comprise the protective agent.

14. The method of any one of claims 5 to 13, wherein the medium is capable of supporting growth of the population of microorganisms.

15. The method of claim 14 further comprising fermenting the population of microorganisms.

16. The method of claim 15, wherein the protective agent is added to the medium prior to or at the beginning of the fermenting step.

17. The method of claim 15 or 16, wherein the protective agent is added to the medium between the early-log growth phase and the late-log growth phase of the fermenting step.

18. The method of any one of claims 15 to 17, wherein the protective agent is added to the medium before the stationary phase of the fermenting step.

19. The method of any one of claims 15 to 18, wherein the protective agent is added to the medium at the stationary phase of the fermenting step.

20. The method of any one of claims 15 to 19, further comprising, after the fermenting step, adding the protective agent to the population of microorganisms.

21. The method of claim 20 further comprising storing the population of microorganisms comprising the protective agent.

22. The method of any one of claims 15 to 21, wherein the yield of the population of microorganism is increased during fermentation by 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290 or 300% when compared to a corresponding population of microorganisms fermented in the absence of the protective agent.

23. The method of any one of claims 1 to 22, wherein the protective agent comprises particles having a size less than 1000, 950, 900, 850, 800, 750, 700, 650, 600, 550, 500, 450, 400, 350, 300, 250, 200, 150, 100, 90, 80, 70, 60, 50, 40, 30, 20 or 10 microns.

24. The method of claim 23, wherein the size of the particles is less than 350, 300, 250, 200, 150, 100, 90, 80, 70, 60, 50, 40, 30, 20 or 10.

25. The method of any one of claims 1 to 24, wherein the population of microorganisms comprise bacterial or fungal cells.

26. The method of claim 25, wherein the bacterial or fungal cells are from the genera Achromobacter, Actimomycetes, Agrobacterium, Arthrobacter, Azospirillum, Azotobacter, Bacillus, Bifidobacterium, Bradyrhizobium, Chromobacterium, Cyanobacteria, Delftia, Enterobacter, Herbaspirillum, Klebsiella, Lactobacillus, Lactococcus, Lysobacter, Methylobacterium, Mitsuaria, Paenibacillus, Pasteuria, Pseudomonas, Rhizobium, Serratia, Sinorhizobium, Streptococcus, Streptomyces, Beauveria, Metarhizium, Isaria, Penicillium, Trichoderma, Chaetomium, Piriformospora, Phlebiopsis or Clonostachys.

27. The method of claim 25, wherein the bacterial or fungal cells are from the genera Azospirillum, Bradyrhizobium, Delftia, Herbaspirillum, Mesorhizobium, Rhizobium, Sinorhizobium, Piriformospora or Streptomyces.

28. The method of claim 25, wherein the bacterial or fungal cells comprise Bradyrhizobium elkanii, Bradyrhizobium diazoefficiens, Delftia acidovorans, Bradyrhizobium japonicum, Rhizobium leguminosarum, Rhizobium tropici, Mesorhizobium loti, Azospirillum brazilense, Herbaspirillum huttiense, Streptomyces griseoviridis, Piriformospora indica, or Sinorhizobium meliloti.

29. The method of claim 25, wherein the bacterial cells comprise Bradyrhizobium elkanii, Delftia acidovorans, Herbaspirillum huttiense, Rhizobium leguminosarum or Azospirillum brazilense.

30. A microbial composition comprising (i) a population of microorganisms and (ii) a protective agent comprising biochar particles, activated carbon, and/or charcoal.

31. The microbial composition of claim 30, wherein the protective agent comprises or consists essentially of biochar particles.

32. The microbial composition of claim 30, wherein the protective agent comprises or consists essentially of activated carbon.

33. The microbial composition of any one of claims 30 to 32 further comprising (iii) a medium.

34. The microbial composition of claim 33, wherein the medium is a liquid medium or a solid substrate.

35. The microbial composition of claim 34 being a liquid inoculant.

36. The microbial composition of claim 33, wherein the medium is a solid substrate.

37. The microbial composition of claim 36 being a microbial inoculant immobilized in the solid substrate.

38. The microbial composition of any one of claims 33 to 37, wherein the medium is capable of supporting the growth of the population of microorganisms.

39. The microbial composition of any one of claims 30 to 38, wherein the protective agent is present at a concentration of 0.01% to 50%, 0.05% to 20%, 0.1% to 15%, 0.1% to 10% or 0.1% to 5% weight/volume of the microbial composition.

40. The microbial composition of any one of claims 30 to 39, wherein the protective agent comprises particles having a size less than 1000, 950, 900, 850, 800, 750, 700, 650, 600, 550, 500, 450, 400, 350, 300, 250, 200, 150, 100, 90, 80, 70, 60, 50, 40, 30, 20 or 10.

41. The microbial composition of any one of claims 30 to 40, wherein the size of the particles is less than 350, 300, 250, 200, 150, 100, 90, 80, 70, 60, 50, 40, 30, 20 or 10.

42. The microbial composition of any one of claims 30 to 41, wherein the population of microorganisms comprise bacterial or fungal cells.

43. The microbial composition of claim 42, wherein the bacterial or fungal cells are from the genera Achromobacter, Actimomycetes, Agrobacterium, Arthrobacter, Azospirillum, Azotobacter, Bacillus, Bifidobacterium, Bradyrhizobium, Chromobacterium, Cyanobacteria, Delftia, Enterobacter, Herbaspirillum, Klebsiella, Lactobacillus, Lactococcus, Lysobacter, Methylobacterium, Mitsuaria, Paenibacillus, Pasteuria, Pseudomonas, Rhizobium, Serratia, Sinorhizobium, Streptococcus, Streptomyces, Beauveria, Metarhizium, Isaria, Penicillium, Trichoderma, Chaetomium, Piriformospora, Phlebiopsis or Clonostachys.

44. The microbial composition of claim 42, wherein the bacterial or fungal cells are from the genera Azospirillum, Bradyrhizobium, Delftia, Herbaspirillum, Mesorhizobium, Rhizobium, Sinorhizobium, Piriformospora or Streptomyces.

45. The microbial composition of claim 42, wherein the bacterial or fungal cells comprise Bradyrhizobium elkanii, Bradyrhizobium diazoefficiens, Delftia acidovorans, Bradyrhizobium japonicum, Rhizobium leguminosarum, Rhizobium tropici, Mesorhizobium loti, Azospirillum brazilense, Herbaspirillum huttiense, Streptomyces griseoviridis, Piriformospora indica or Sinorhizobium meliloti.

46. The microbial composition of claim 42, wherein the bacterial cells comprise Bradyrhizobium elkanii, Delftia acidovorans, Herbaspirillum huttiense, Rhizobium leguminosarum or Azospirillum brazilense.
